(19) United States
(12) Patent Application Publication
(10) Pub. No.: US 2025/0339985 A1
(43) Pub. Date: Nov. 6, 2025

(54) RAZOR CARTRIDGE PROTECTIVE CASE

(71) Applicant: DORCO CO., LTD., Yongin-si (KR)

(72) Inventor: Jong Jin JEONG, Seoul (KR)

(21) Appl. No.: 19/198,451

(22) Filed: May 5, 2025

(30) Foreign Application Priority Data
May 3, 2024 (KR) 10-2024-0059318

(51) Int. Cl. B26B 21/40; B26B 21/22; B26B 21/44

(52) U.S. Cl. CPC B26B 21/4037; B26B 21/222; B26B 21/4018; B26B 21/4025; B26B 21/443

(57) ABSTRACT

Proposed is a razor cartridge protective case including a receiving space configured to receive at least a portion of a razor cartridge that includes at least one razor blade extending in a longitudinal direction. The razor cartridge protective case may include a front wall disposed at a front of the receiving space and configured to face a front surface of the razor cartridge, where a cutting edge of the at least one razor blade is exposed. The case may also include a longitudinal side wall disposed on one longitudinal side of the receiving space. The case may further include a first extension wall disposed at a rear of the receiving space and extending from the longitudinal side wall, wherein the first extension wall is configured to be coupled to a rear surface of the razor cartridge.

### CROSS-REFERENCE TO RELATED APPLICATION

This application claims the benefit of and priority to Korean Patent Application No. 10-2024-0059318, filed on May 3, 2024, the entire disclosure(s) of which is hereby incorporated herein by reference in its entirety.

### BACKGROUND

### Technical Field

The present disclosure relates to a razor cartridge protective case.

### Description of Related Technology

Typically, a razor cartridge is often sold coupled to a protective case in the shape of a cover. Thereby, it is possible to prevent the razor cartridge from being damaged when transporting or selling the product, and to prevent safety issues from users being cut by the razor blades.

### SUMMARY

One aspect is a razor cartridge protective case that can improve the functions required for the protective case while minimizing the amount of plastic materials used.

Another aspect is a razor cartridge protective case comprising a receiving space configured to receive at least a portion of a razor cartridge comprising at least one razor blade extending in a longitudinal direction, the razor cartridge protective case comprising: a front wall disposed at a front of the receiving space and configured to face a front surface of the razor cartridge, where a cutting edge of the at least one razor blade is exposed; a longitudinal side wall disposed on one longitudinal side of the receiving space; and a first extension wall disposed at a rear of the receiving space and extending from the longitudinal side wall, wherein the first extension wall is configured to be coupled to a rear surface of the razor cartridge.

According to an embodiment of the present disclosure described above, a razor cartridge protective case capable of improving the functions required for the protective case while minimizing the amount of plastic materials used can be provided.

### BRIEF DESCRIPTION OF THE DRAWINGS

FIG. 1 is a perspective view showing an example of a razor cartridge being received in a razor cartridge protective case according to an embodiment of the present disclosure from the front in the width direction.

FIG. 2 is a view showing an example of a razor cartridge being received in a razor cartridge protective case according to an embodiment of the present disclosure from the top.

FIG. 3 is a perspective view showing an example of a razor cartridge protective case and a razor cartridge being disassembled according to an embodiment of the present disclosure from the front in the width direction.

FIG. 4 is a perspective view showing an example of a razor cartridge protective case and a razor cartridge being disassembled according to an embodiment of the present disclosure from the rear in the width direction.

FIG. 5 is a view showing a razor cartridge protective case according to an embodiment of the present disclosure from the bottom.

FIG. 6 is a cross-sectional view of the razor cartridge protective case and the razor cartridge of FIGS. 1 and 2 taken along direction A-A′.

FIG. 7 is a cross-sectional view of the razor cartridge protective case and the razor cartridge of FIGS. 1 and 2 taken along direction B-B′.

### DETAILED DESCRIPTION

Even after the razor cartridge is used, a user may couple the razor cartridge to the protective case to protect the razor cartridge from external impacts and contaminants. In this connection, the protective case may be required to not only protect the razor cartridge but also discharge residues remaining in the razor cartridge. In a wet environment, such as an environment where moisture remains in the razor cartridge, the protective case with air permeability may be needed to prevent corrosion of the razor blades.

In addition, the razor cartridge needs to be firmly coupled to the protective case and the coupling state needs to be maintained even when subjected to external impacts. Accordingly, the protective case needs to be durable enough to maintain the coupling force with the razor cartridge even after repeated attachment and detachment of the razor cartridge. However, for convenience of storage and carrying, the protective case needs to be configured to be durable but not too heavy in itself.

As the seriousness of environmental destruction has recently emerged, every country and various international organizations are establishing measures related to environmental regulations. For example, countermeasures such as banning the use of disposable plastics or reducing the amount of plastic used are being established. In this regard, there is a need to minimize the amount of plastic materials used in the manufacture of the protective case.

Hereinafter, some embodiments of the present disclosure will be described in detail with reference to the accompanying drawings. It is to be noted that in giving reference numerals to components of each of the accompanying drawings, the same components will be denoted by the same reference numerals even though they are illustrated in different drawings. Further, in describing exemplary embodiments of the present invention, well-known functions or constructions will not be described in detail since they may unnecessarily obscure the understanding of the present invention.

Terms ‘first’, ‘second’, i), ii), a), b), and the like, will be used in describing components according to embodiments of the present disclosure. These terms are only for distinguishing the components from other components, and the nature, sequence, order, or the like of the components are not limited by the terms. Throughout the present specification, unless explicitly described to the contrary, “including” or “comprising” any components will be understood to imply the inclusion of other elements rather than the exclusion of any other elements.

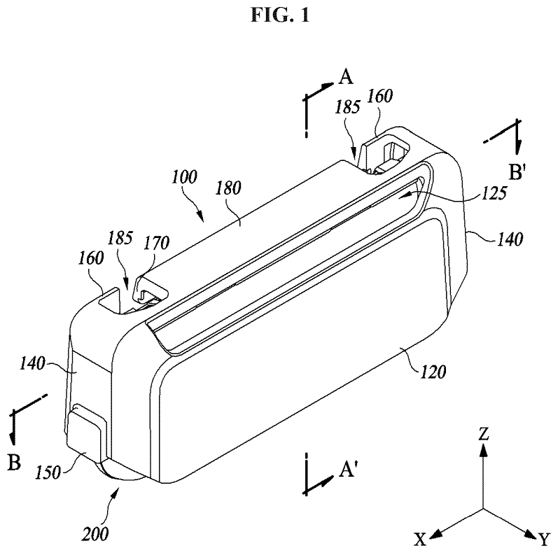

FIG. 1 is a perspective view showing an example of a razor cartridge 200 being received in a razor cartridge protective case 100 according to an embodiment of the present disclosure from the front in the width direction.

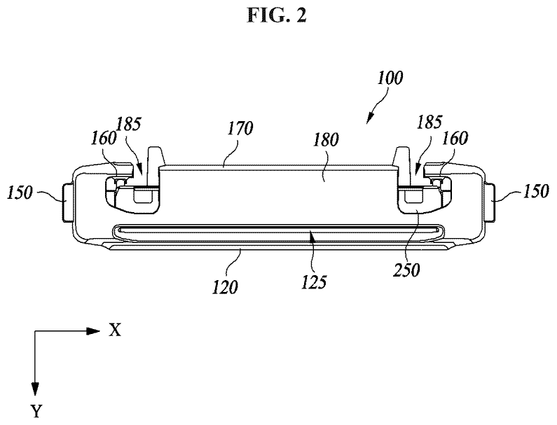

FIG. 2 is a view showing an example of the razor cartridge 200 being received in the razor cartridge protective case 100 according to an embodiment of the present disclosure from the top.

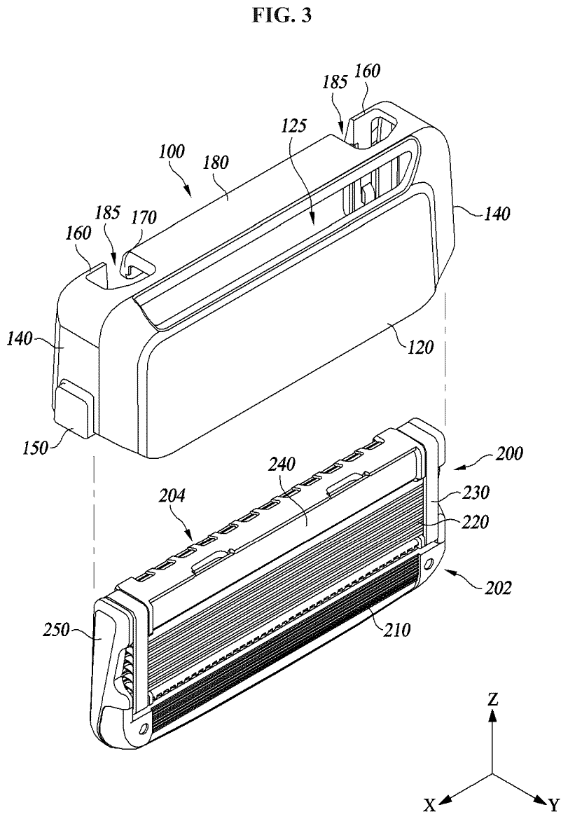

FIG. 3 is a perspective view showing an example of the razor cartridge protective case 100 and the razor cartridge 200 being disassembled according to an embodiment of the present disclosure from the front in the width direction.

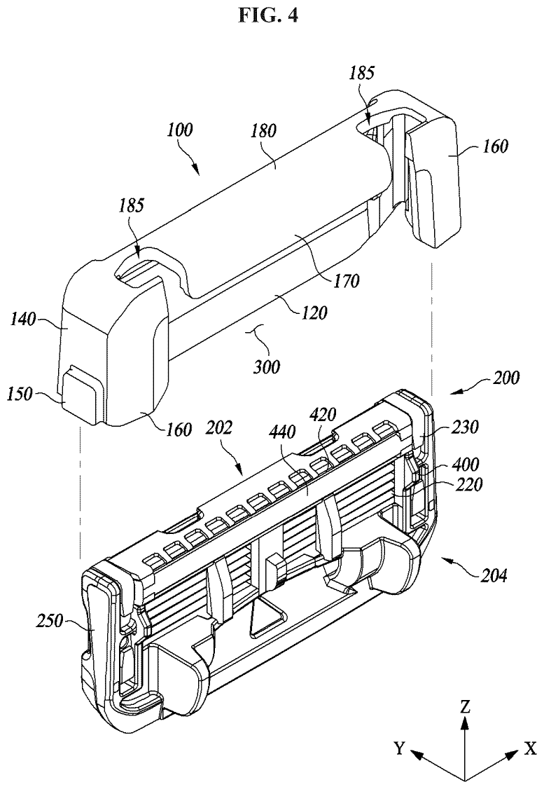

FIG. 4 is a perspective view showing an example of the razor cartridge protective case 100 and the razor cartridge 200 being disassembled according to an embodiment of the present disclosure from the rear in the width direction.

Referring to FIGS. 1 to 4, the razor cartridge protective case 100 according to an embodiment of the present disclosure comprises all or part of receiving space 300, a front wall 120, a front opening 125, a longitudinal side wall 140, a first extension wall 160, a protruding unit 150, an upper wall 180, an upper opening 185, and a second extension wall 170.

The receiving space 300 is configured to receive at least a portion of the razor cartridge 200. The razor cartridge 200 may comprise at least one razor blade 220 extending in a longitudinal direction. Herein, the longitudinal direction may be a longitudinal direction of the razor cartridge protective case 100, for example, a direction parallel to the X axis in FIGS. 1 to 4.

The front wall 120 is disposed on the front side of the receiving space 300 in the width direction, and is configured to face a front surface 202 of the razor cartridge 200 with exposed cutting edge of the at least one razor blade 220. Herein, the width direction may be a width direction of the razor cartridge protective case 100, for example, a direction parallel to the Y axis in FIGS. 1 to 4. The width direction may be perpendicular to the longitudinal direction.

In addition, the front in the width direction may mean the positive Y-axis direction in FIGS. 1 to 4, and the rear with respect to the width direction may mean the negative Y-axis direction in FIGS. 1 to 4. Hereinafter, the front in the width direction will be described as front, and the rear in the width direction will be described as rear.

The front opening 125 is configured to open the front wall 120 in a direction parallel to the width direction, and is located on one side of the front wall 120 in a lateral direction perpendicular to the longitudinal direction. Herein, the lateral direction is the height direction of the razor cartridge protective case 100 and is the direction perpendicular to the longitudinal and width directions, and may mean, for example, the direction parallel to the Z-axis direction in FIGS. 1, 3, and 4. The detailed description of the front opening 125 will be described later.

In a state where the razor cartridge 200 is received in the razor cartridge protective case 100, moisture and shaving residues remaining in the receiving space 300 may be discharged not only through the other side of the receiving space 300 in the lateral direction but also through the front opening 125. In addition, air may be circulated through the front opening 125.

The longitudinal side wall 140 is disposed on one side of the receiving space 300 in the longitudinal direction, and the first extension wall 160 extends from the longitudinal side wall 140 toward the rear side of the receiving space 300.

Each of the longitudinal side walls 140 in a pair is disposed on each of both longitudinal sides of the receiving space 300, and accordingly, each of the first extension walls 160 in a pair is illustrated as extending from each of the longitudinal side walls 140 in the pair, but is not necessarily limited thereto. However, the descriptions of the longitudinal side wall 140 and the first extension wall 160 below may equally be applied to each of the longitudinal side walls 140 in the pair and each of the first extension walls 160 in the pair illustrated in FIGS. 1 to 4.

The first extension wall 160 may be coupled to a rear surface 204 of the razor cartridge 200. In this connection, the central region of the receiving space in the longitudinal direction of the receiving space may be open to the rear, and moisture and shaving residues remaining in the receiving space 300 in a state where the razor cartridge 200 is received in the razor cartridge protective case 100 may be discharged through the rear of the receiving space 300. In addition, air may be circulated through the rear of the receiving space 300.

In addition, the first extension wall 160 is configured to be coupled to the rear surface 204 of the razor cartridge 200, and thus there is no need to form a wall that blocks the entire rear of the receiving space 300. Accordingly, the amount of plastic used to manufacture the razor cartridge protective case 100 may be reduced.

The protruding unit 150 may be formed by protruding from a portion of an outer surface of the longitudinal side wall 140. In a state where the razor cartridge 200 is received in the razor cartridge protective case 100, a user may easily separate the razor cartridge 200 and the razor cartridge protective case 100 by holding the protruding unit 150.

The protruding unit 150 is illustrated as being formed on the other side of the longitudinal side wall 140 in the lateral direction, for example, one end in a negative Z-axis direction, but is not necessarily limited thereto.

The upper wall 180 may be disposed on an upper portion of the receiving space 300. Herein, the upper portion may mean one side in the lateral direction, for example, the positive Z-axis direction, and the lower portion may mean the other side in the lateral direction, for example, the negative Z-axis direction.

The front opening 125 may open a portion of the upper wall 180 in a direction parallel to the lateral direction. In this connection, moisture and shaving residues may be discharged through the front opening 125, and air may be circulated. Moreover, the moisture and shaving residues may be discharged to the upper portion and/or the lower portion of the receiving space 300 and the air may be circulated.

The upper opening 185 may be configured to open at least a portion of the upper wall 180. For example, the upper opening 185 may open at least a portion of the upper wall 180 in a direction perpendicular to the upper wall 180. Thereby, in a state where the razor cartridge 200 is received in the razor cartridge protective case 100, moisture and shaving residues remaining in the receiving space 300 may also be discharged through the upper opening 185. In addition, air may be circulated through the upper opening 185.

In addition, the upper opening 185 is formed so that the entire area of the upper wall 180 is reduced. Accordingly, the amount of plastic needed to manufacture the razor cartridge protective case 100 may be reduced comparatively, and accordingly, the overall weight of the razor cartridge protective case 100 may also be reduced.

The upper opening 185 may be located on one longitudinal side of the upper wall 180. Each of the upper openings 185 in a pair is illustrated as being disposed on each of both longitudinal sides of the upper wall 180, but is not necessarily limited thereto. However, the description of the upper opening 185 below may equally be applied to each of the upper openings 185 in the pair illustrated in FIGS. 1 to 4.

As the size of the upper opening 185 increases, the amount of plastic used decreases and the discharge of moisture and shaving residues or the circulation of air may become easier. However, it is preferable that the size of the upper opening 185 be adjusted within a range that does not significantly reduce the durability of the razor cartridge protective case 100.

Referring to FIG. 2, the upper opening 185 may extend at least partially to the rear side of the upper wall 180.

For example, the upper opening 185 may be configured such that a portion thereof in the longitudinal direction extends to a region adjacent to the rear side of the upper wall 180, and another portion thereof based on the longitudinal direction extends to the rear side of the upper wall 180. Herein, a portion of the upper opening 185 in the longitudinal direction is a region adjacent to the first extension wall 160, a free end of the first extension wall 160 may be formed by another portion thereof based on the longitudinal direction of the upper opening 185, and the upper wall 180 may be opened toward the rear.

Thereby, the first extension wall 160 may be elastically deformable, and thus at least a portion of the first extension wall 160 may be configured to pivot. However, as long as the first extension wall 160 is configured to be elastically deformable, the shape of the upper opening 185 is not necessarily limited to the shape illustrated in FIG. 2.

The second extension wall 170 may extend from the rear side of the upper wall 180 to the other side in the lateral direction, in other words, in the negative Z-axis direction. In this connection, the first extension wall 160 and the second extension wall 170 may be longitudinally spaced apart through an open portion of the upper opening 185, and the first extension wall 160 and the second extension wall 170 may move independently of each other.

For example, when at least a portion of the upper opening 185 is configured to extend to the rear side of the upper wall 180 and open a portion of the first extension wall 160 and/or the second extension wall 170 rearwardly, the free end of the second extension wall 170 and the free end of the first extension wall 160 may be spaced apart in the longitudinal direction through the upper opening 185. In this connection, elastic deformation of the first extension wall 160 may be promoted through the upper opening 185.

The elastic deformation of the first extension wall 160 may facilitate the separation of the razor cartridge 200 and the razor cartridge protective case 100 by a user. For example, the user may release the coupling state of the razor cartridge 200 and the razor cartridge protective case 100 by elastically deforming the first extension wall 160 in a direction parallel to the front-rear and/or longitudinal direction.

In addition, since the first extension wall 160 may be elastically deformed when the razor cartridge 200 and the razor cartridge protective case 100 are coupled and disengaged, less force may be used than when the first extension wall 160 is not elastically deformed, making coupling and disengaging easier.

Since the second extension wall 170 may play a role in protecting a trimming blade 420 and a trimmer cap 440 described later, it is preferable that the second extension wall 170 be configured so that excessive elastic deformation does not occur.

In order to suppress elastic deformation, the lateral thickness of the region of the upper wall 180 adjacent to the region extending along the outer edge of the upper opening 185 from the front side of the upper opening 185 to the side adjacent to the second extension wall 170 may be thicker than the lateral thickness of other regions. For example, the lateral thickness of the region of the upper wall may be about 1.3 mm, and may be about 0.8 mm thicker than the lateral thickness of other regions, but is not necessarily limited thereto.

Referring to FIG. 4, the first extension wall 160 may be configured so that the length of a support end on a side where the first extension wall 160 is supported is greater than a length extending from the support end to the free end of the first extension wall 160. More specifically, the lateral length of the support end may be formed longer than the longitudinal extension length of the first extension wall 160.

Herein, the support end may mean one side of the first extension wall 160 in the longitudinal direction, for example, an end of the first extension wall 160 on the side adjacent to the longitudinal side wall 140.

When the length of the support end of the first extension wall 160 is shorter than the length extending from the support end, it is difficult to sufficiently withstand the external force applied to the portion extending from the support end, and thus the first extension wall 160 may easily break when the razor cartridge 200 and the razor cartridge protective case 100 are coupled and separated. Accordingly, in order to ensure durability while allowing the pivot and/or elastic deformation of the first extension wall 160, it is preferable that the length of the support end of the first extension wall 160 be longer than the length extending from the support end.

The razor cartridge protective case 100 according to an embodiment of the present disclosure may include a polymer resin material. For example, the razor cartridge protective case 100 may comprise eco-friendly materials such as waste plastic, biodegradable plastic, elastic material, or flexible material, and preferably may comprise polypropylene.

When the razor cartridge protective case 100 is configured to include polypropylene, the razor cartridge protective case 100 may have a lighter overall weight and strong bending strength while being flexible. In addition, when the razor cartridge protective case 100 includes a more flexible material than the conventional protective case, the protection of the razor cartridge 200 may be achieved even with a relatively thinner thickness.

When the razor cartridge protective case 100 is too thin in thickness, the durability of the razor cartridge protective case 100 deteriorates. When the razor cartridge protective case 100 is too thick in thickness, the plastic usage and weight of the razor cartridge protective case 100 increases. Accordingly, it is necessary to appropriately adjust the thickness range. In addition, in order to prevent shrinkage deformation during an injection molding process, the razor cartridge protective case 100 may have a uniform thickness throughout the front wall 120, the longitudinal side wall 140, the first extension wall 160, and the second extension wall 170. For example, the thickness may be 0.6 mm to 1.3 mm, preferably 0.8 mm, but is not necessarily limited thereto.

In addition, the weight of the razor cartridge protective case 100 is affected by the structure, material, and thickness of the protective case, and it is preferable that the weight of the razor cartridge protective case 100 be light within a range that may secure the durability of the razor cartridge protective case 100. For example, the weight of the razor cartridge protective case 100 may be 0.6 g to 1.4 g, preferably 1 g, and more preferably 0.8 g, but is not necessarily limited thereto.

In addition, the razor cartridge protective case 100 may include a transparent material to easily check the receiving state of the razor cartridge 200, but is not necessarily limited thereto and may include an opaque material.

Referring to FIGS. 3 and 4, the razor cartridge 200 may comprise a blade housing 250, a guard unit 210, a cap unit 240, a clip 230, a trimming blade 420, a trimmer cap 440, and a cartridge coupling portion 400.

The blade housing 250 may receive at least one razor blade 220.

The guard unit 210 may be located on the other side of the at least one razor blade 220 in the lateral direction, for example, the negative Z-axis direction. The guard unit 210 may stretch the skin before the hair is cut by the at least one razor blade 220 during a shaving process.

The cap unit 240 may be located on one side of the at least one razor blade 220 in the lateral direction, for example, the positive Z-axis direction. The cap unit 240 may include a lubricating material, and may play a role in protecting the skin of a user when shaving.

The clip 230 may be disposed on one side of the at least one razor blade 220 in the longitudinal direction, and may fix the at least one razor blade 200 to the blade housing 250.

The trimming blade 420 may be disposed on the rear surface 204 of the razor cartridge 200, and be configured to cut the hair during trimming shaving. The trimming blade 420 may provide a precise trimming shave for areas of skin with many curves or areas requiring a precise shave, such as under the nose, near the ears, and areas of skin near the ears.

The trimmer cap 440 may be coupled to the blade housing 250 in a direction from the rear of the razor cartridge 200 toward the front, for example, from the negative Y-axis direction to the positive Y-axis direction, to fix the trimming blade 420 to the blade housing 250.

When viewed from the rear, at least a portion of the trimming blade 420 and the trimmer cap 440 may be blocked from view by the second extension wall 170 of the razor cartridge protective case 100. Accordingly, the trimming blade 420 and the trimmer cap 440 may be protected by the second extension wall 170.

The cartridge coupling portion 400 is configured to be coupled with the first extension wall 160 of the razor cartridge protective case 100. In FIG. 4, the cartridge coupling portion 400 is illustrated as being formed by protruding from a portion of the rear surface 204 of the razor cartridge 200, but is not necessarily limited thereto, and may be formed by recessing a portion of the rear surface 204 of the razor cartridge 200. A detailed description of the coupling between the cartridge coupling portion 400 and the first extension wall 160 will be described later.

Referring again to FIGS. 1 and 2, in a state where the razor cartridge 200 is received in the razor cartridge protective case 100, at least a portion of the guard unit 210 may be exposed from the razor cartridge protective case 100. For example, at least a portion of the guard unit 210 of the razor cartridge 200 may be further exposed in the lateral direction from one end of the razor cartridge protective case 100 in the lateral direction, and a user may separate the razor cartridge 200 from the razor cartridge protective case 100 while holding at least a portion of the guard unit 210.

Referring again to FIGS. 3 and 4, the front wall 120 of the razor cartridge protective case 100 may be configured such that the central region protrudes further forward than both side regions based on the longitudinal direction. This is to prevent damage to the at least one razor blade 220 that may occur when the front wall 120 and the at least one razor blade 220 come into contact while the razor cartridge 200 is received in the receiving space 300.

For example, in a state where the razor cartridge 200 is received in the receiving space 300, the region of the front wall 120 facing the at least one razor blade 220 may protrude further forward than the region of the front wall 120 facing the clip 230.

In this connection, the space between the front wall 120 and the at least one razor blade 220 may also be communicated with the front opening 125, so that the circulation of air or the discharge of moisture and shaving residue within the receiving space 300 may become easier.

Since the cap unit 240 may include a lubricating material, and when the cap unit 240 is continuously wet with water, the lubricating material may also be continuously consumed. For prevention, when the razor cartridge 200 is received in the razor cartridge protective case 100 while the cap unit 240 is wet, it is necessary to make it easier to discharge moisture and dry the cap unit 240. Accordingly, the front opening 125 of the razor cartridge protective case 100 may be formed at a location corresponding to the cap unit 240 of the razor cartridge 200 when the razor cartridge 200 is received in the receiving space 300.

In addition, the longitudinal width of the front opening 125 on one side in the lateral direction adjacent to the upper wall 180 may be equal to or greater than the longitudinal width of the other lateral side. For example, when viewed from the front, the front opening 125 may have a trapezoidal shape.

In this connection, the external exposure of the clip 230 may be prevented, and the external exposure region of the cap unit 240 may be maximized, thereby facilitating the circulation of air through the cap unit 240.

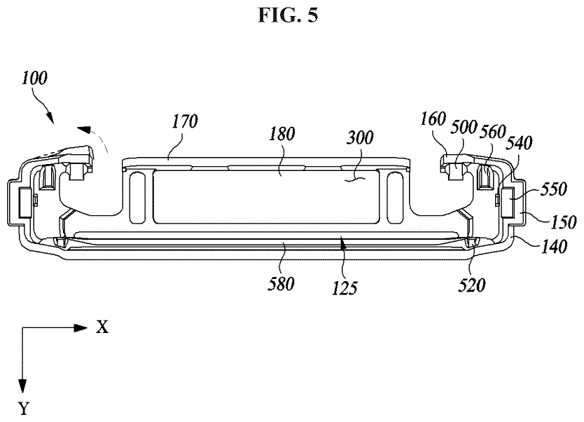

FIG. 5 is a view showing the razor cartridge protective case 100 according to an embodiment of the present disclosure from the bottom.

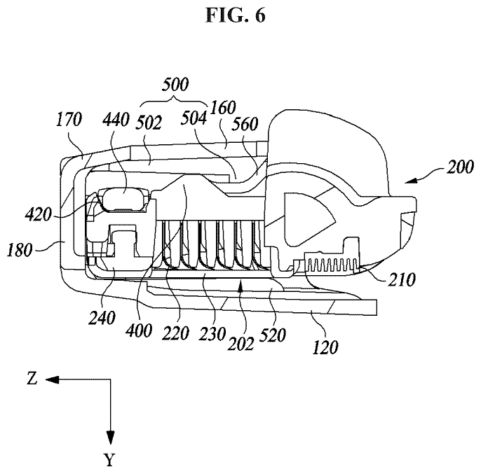

FIG. 6 is a cross-sectional view of the razor cartridge protective case 100 and the razor cartridge 200 of FIGS. 1 and 2 taken along direction A-A′.

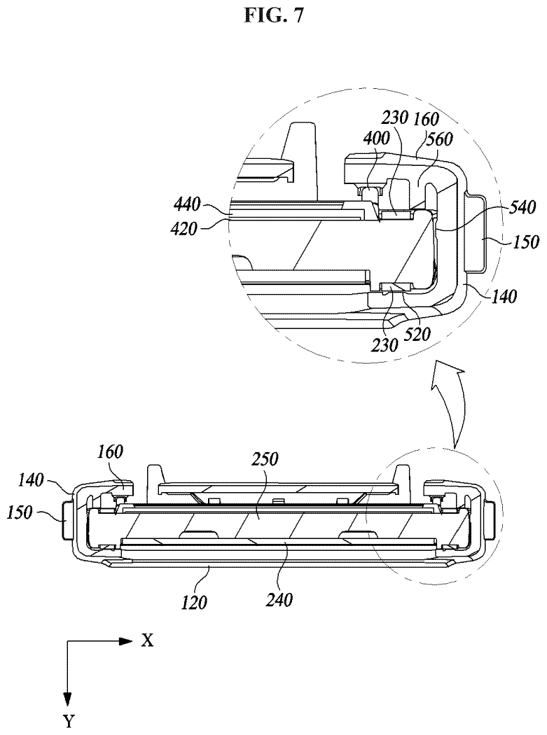

FIG. 7 is a cross-sectional view of the razor cartridge protective case 100 and the razor cartridge 200 of FIGS. 1 and 2 taken along direction B-B′.

Referring to FIGS. 5 to 7, the razor cartridge protective case 100 according to an embodiment of the present disclosure may further comprise a recess portion 550, a coupling protrusion 500, a rear support protrusion 560, a front support protrusion 520, a longitudinal side support protrusion 540, and an inner rib 580.

The recess portion 550 may be formed by recessing a portion of an inner side surface of the longitudinal side wall 140 and may be located to correspond to the location where the protruding unit 150 is formed. The recess portion 550 may be formed in the process of forming the protruding unit 150 using an injection molding method, but is not necessarily limited thereto.

However, when only the protruding unit 150 is formed without the recess portion 550, the overall thickness of the longitudinal side wall 140 may increase, which may increase the amount of plastic used. In addition, the region where the protruding unit 150 is formed may be relatively thicker than the surrounding region, and thus may be cooled relatively slowly during the cooling process in the injection molding process, which may cause shrinkage deformation.

The coupling protrusion 500 may extend from one surface of the first extension wall 160 toward the receiving space 300. In this connection, the coupling protrusion 500 may be coupled with the cartridge coupling portion 400 formed on the rear surface 204 of the razor cartridge 200. In other words, by coupling the cartridge coupling portion 400 and the coupling protrusion 500, the razor cartridge 200 may be received in the receiving space 300.

Referring to FIG. 6, the coupling protrusion 500 may comprise an extension portion 502 and a hook portion 504.

When viewed from one side in the longitudinal direction, the extension portion 502 may form a predetermined angle with respect to one surface of the first extension wall 160. Herein, the predetermined angle may be, for example, about 1.5°, but is not necessarily limited thereto. As a result, the separation of the mold used in manufacturing the razor cartridge protective case 100 may be facilitated.

The hook portion 504 may be disposed on one side of the extension portion 502 in the lateral direction. It is preferable that the hook portion 504 be formed in a shape corresponding to the cartridge coupling portion 400. In this connection, when the cartridge coupling portion 400 is engaged with the hook portion 504, the razor cartridge 200 is stably fixed within the receiving space 300, thereby preventing unintended separation of the razor cartridge 200 and the razor cartridge protective case 100.

Referring to FIG. 5, the rear support protrusion 560 may be spaced apart in the longitudinal direction from the coupling protrusion 500 and may extend from at least one surface of the first extension wall 160 toward the receiving space 300. When the razor cartridge 200 is received in the razor cartridge protective case 100, the rear support protrusion 560 may support the rear surface 204 of the razor cartridge 200. In this connection, the supporting force of the razor cartridge protective case 100 for the rear surface 204 of the razor cartridge 200 may be increased, thereby enabling stable reception of the razor cartridge 200.

The rear support protrusion 560 may be located relatively adjacent to the longitudinal side wall 140 than the coupling protrusion 500. More specifically, the region adjacent to one side of the clip 230 in the longitudinal direction among the rear surfaces 204 of the razor cartridge 200 may be supported by the coupling protrusion 500, and the region adjacent to the other longitudinal side of the clip 230 may be supported by the rear support protrusion 560.

In this connection, the longitudinal distance between the coupling protrusion 500 and the rear support protrusion 560 may be equal to or greater than the longitudinal width of the clip 230. As such, stable support may be possible as the coupling protrusion 500 and the rear support protrusion 560 are appropriately spaced apart in the longitudinal direction.

The razor cartridge protective case 100 according to an embodiment of the present disclosure may be configured such that the first extension wall 160 extends from the longitudinal side wall 140 toward the rear side of the receiving space 300. In this connection, the first extension wall 160 may be configured to be parallel to the rear surface 204 of the razor cartridge 200 and may comprise a configuration for being coupled to the razor cartridge 200 or supporting the razor cartridge 200.

The front support protrusion 520 may extend from one surface of the front wall 120 toward the receiving space 300. In a state where the razor cartridge 200 is received in the razor cartridge protective case 100, the front support protrusion 520 may support the front surface 202 of the razor cartridge 200. In this connection, the supporting force of the razor cartridge protective case 100 for the front surface 202 of the razor cartridge 200 may be increased, thereby enabling stable reception of the razor cartridge 200.

The front support protrusion 520 may be located between the coupling protrusion 500 and the rear support protrusion 560 based on the direction parallel to the longitudinal direction. In order to more firmly support the razor cartridge 200 received in the receiving space 300, it may be desirable to support both the front and rear surfaces of the razor cartridge 200.

However, since the at least one razor blade 200 is exposed on the front surface of the razor cartridge 200, in order to avoid contact with the at least one razor blade 200, a region adjacent to the longitudinal center of the clip 230 of the front surface 202 of the razor cartridge 200 may be supported by the front support protrusion 520. Since the clip 230 and the region adjacent thereto of the front surface 202 of the razor cartridge 200 may protrude with respect to the at least one razor blade 200, the front support protrusion 520 may be suitable as a region to be supported.

Accordingly, even in a situation where the razor cartridge 200 may be shaken by external impact while being received in the receiving space 300, the razor cartridge 200 may be stably supported.

In addition, the lateral length of the front support protrusion 520 may be configured to be longer than the lateral lengths of the coupling protrusion 500 and the rear support protrusion 560. The longitudinal width of the front support protrusion 520 may be smaller than the longitudinal width of the clip 230.

As a result, the overall amount of plastic used may be reduced, and damage to the clip 230 that may occur due to the contact surface with the clip 230 becoming excessively wide may also be prevented.

The front support protrusion 520 may support the clip 230 on the front surface 202 of the razor cartridge 200 as a whole, and for example, the lateral length of the front support protrusion 520 may be at least 80% or more of the lateral length of the clip 230 on the front surface 202 of the razor cartridge 200, but is not necessarily limited thereto.

Since the lateral length of the front support protrusion 520 is longer than that of the coupling protrusion 500 and the rear support protrusion 560, the supporting force for the front surface 202 of the razor cartridge 200, which may be relatively weak compared to the supporting force for the rear surface 204 of the razor cartridge 200 supported by the coupling protrusion 500 and the rear support protrusion 560, may be further increased.

In addition, referring to FIG. 6, when the razor cartridge 200 is received in the receiving space 300, at least a portion of the front wall 120 may be spaced apart from the front surface 202 of the razor cartridge 200 by a length greater than that over which the front support protrusion 520 extends. In this connection, while securing the supporting force for the front surface 202 of the razor cartridge 200, the space between the front wall 120 and the at least one razor blade 220 and the area of communication by the front opening 125 may be maximized.

The longitudinal thickness of the coupling protrusion 500, the rear support protrusion 560, and the front support protrusion 520 may be configured to a thickness similar to the thickness of the walls forming the outer edge of the razor cartridge protective case 100. In this connection, the razor cartridge protective case 100 may be prevented from shrinking unintentionally during the injection molding process.

Referring to FIGS. 5 and 7, the longitudinal side support protrusion 540 is configured to support one side of the razor cartridge 200 in the longitudinal direction while the razor cartridge 200 is received in the receiving space 300. In this connection, the supporting force of the razor cartridge protective case 100 toward the side of the razor cartridge 200 may be increased, thereby enabling stable reception of the razor cartridge 200.

The inner rib 580 may protrude from a region adjacent to the front opening 125 of the front wall 120 toward the receiving space 300. In a case where the razor cartridge protective case 100 is pressurized by an external impact while the razor cartridge 200 is received in the receiving space 300, the inner rib 580 may prevent the at least one razor blade 220 from contacting the front wall 120 by first contacting the cap unit 240.

The spirit of the present embodiment is illustratively described hereinabove. It will be appreciated by those skilled in the art to which the present embodiment pertains that various modifications and alterations may be made without departing from the essential characteristics of the present embodiment. Accordingly, the present embodiments are not to limit the spirit of the present embodiment, but are to describe the spirit of the present embodiment. The technical idea of the present embodiment is not limited to these embodiments. The scope of the present embodiment should be interpreted by the following claims, and it should be interpreted that all the spirits equivalent to the following claims fall within the scope of the present embodiment.

What is claimed is:

1. A razor cartridge protective case comprising a receiving space configured to receive at least a portion of a razor cartridge comprising at least one razor blade extending in a longitudinal direction, the razor cartridge protective case comprising:
a front wall disposed at a front of the receiving space and configured to face a front surface of the razor cartridge, where a cutting edge of the at least one razor blade is exposed;
a longitudinal side wall disposed on one longitudinal side of the receiving space; and
a first extension wall disposed at a rear of the receiving space and extending from the longitudinal side wall,
wherein the first extension wall is configured to be coupled to a rear surface of the razor cartridge.

2. The razor cartridge protective case of claim 1, further comprising:
an upper wall disposed on an upper portion of the receiving space; and
an upper opening configured to open at least a portion of the upper wall.

3. The razor cartridge protective case of claim 2, wherein the upper opening is located on one longitudinal side of the upper wall, and wherein at least a portion thereof extends to a rear side of the upper wall.

4. The razor cartridge protective case of claim 2, further comprising a second extension wall extending from a rear side of the upper wall,
wherein the first extension wall and the second extension wall are spaced apart from each other in the longitudinal direction.

5. The razor cartridge protective case of claim 2, wherein the upper opening is configured to facilitate elastic deformation of the first extension wall.

6. The razor cartridge protective case of claim 4, wherein a free end of the second extension wall and a free end of the first extension wall are spaced apart from each other in the longitudinal direction through the upper opening.

7. The razor cartridge protective case of claim 1, further comprising a coupling protrusion extending from one surface of the first extension wall toward the receiving space,
wherein the coupling protrusion is configured to be coupled to a cartridge coupling portion formed on the rear surface of the razor cartridge.

8. The razor cartridge protective case of claim 7, wherein the coupling protrusion comprises:
an extension portion configured to form a predetermined angle with respect to one surface of the first extension wall when viewed from one side in the longitudinal direction; and
a hook portion disposed on one side of the extension portion in a lateral direction perpendicular to the longitudinal direction.

9. The razor cartridge protective case of claim 7, further comprising a rear support protrusion spaced apart in the longitudinal direction from the coupling protrusion and extending from at least one surface of the first extension wall toward the receiving space.

10. The razor cartridge protective case of claim 1, further comprising a front support protrusion extending from one surface of the front wall toward the receiving space,
wherein the front support protrusion is configured to support the front surface of the razor cartridge in a state where the razor cartridge is received in the receiving space.

11. The razor cartridge protective case of claim 10, further comprising:
a coupling protrusion extending from one surface of the first extension wall toward the receiving space; and
a rear support protrusion spaced apart in the longitudinal direction from the coupling protrusion and extending from at least one surface of the first extension wall toward the receiving space,
wherein the front support protrusion is located between the coupling protrusion and the rear support protrusion based on a direction parallel to the longitudinal direction.

12. The razor cartridge protective case of claim 1, further comprising a longitudinal side support protrusion extending from one surface of the longitudinal side wall toward the receiving space,
wherein longitudinal side support protrusion is configured to support one longitudinal side of the razor cartridge in a state where the razor cartridge is received in the receiving space.

13. The razor cartridge protective case of claim 1, wherein at least a portion of the first extension wall is configured to pivot.

14. The razor cartridge protective case of claim 1, wherein the first extension wall is configured so that a length of a support end on a side where the first extension wall is supported is greater than a length extending from the support end to a free end of the first extension wall.

15. The razor cartridge protective case of claim 1, further comprising a protruding unit formed by protruding from a portion of an outer surface of the longitudinal side wall.

16. The razor cartridge protective case of claim 1, further comprising a front opening configured to open the front wall in a direction from the front to the rear and is located on one side of the front wall in a lateral direction perpendicular to the longitudinal direction.

17. The razor cartridge protective case of claim 16, further comprising an upper wall disposed on an upper portion of the receiving space,
wherein the front opening is configured to open a portion of the upper wall in a direction parallel to the lateral direction.

18. The razor cartridge protective case of claim 16, further comprising a front support protrusion extending from one surface of the front wall toward the receiving space,
wherein at least a portion of the front wall is spaced apart from the front surface of the razor cartridge by a length greater than a length by which the front support protrusion extends in a state where the razor cartridge is received in the receiving space.

19. The razor cartridge protective case of claim 1, wherein the razor cartridge protective case comprises eco-friendly materials.
